(19) United States
(12) Patent Application Publication
(10) Pub. No.: US 2012/0276506 A1
(43) Pub. Date: Nov. 1, 2012

(54) Method of Treatment

(76) Inventor: Yoko Nagai, East Sussex (GB)

(21) Appl. No.: 13/454,638

(22) Filed: Apr. 24, 2012

Related U.S. Application Data
(60) Provisional application No. 61/479,028, filed on Apr. 26, 2011.

(51) Int. Cl. G09B 19/00

(52) U.S. Cl. 434/238

(57) ABSTRACT

This invention relates to the treatment of neuropsychiatric disorders in sufferers thereof. Neuropsychiatric disorders are shown to be treatable using a biofeedback method in which sympathetic activity in the patient is enhanced.

### CROSS REFERENCE TO RELATED APPLICATION

This application claims benefit of U.S. Provisional Application Ser. No. 61/479,028 entitled, “Method of Treatment,” filed Apr. 26, 2011, the entire disclosure of which is incorporated herein by reference.

### FIELD OF THE INVENTION

This invention relates to the treatment of neuropsychiatric disorders in sufferers thereof. In particular although not exclusively the invention relates to the treatment of Attention Deficit Disorder (ADD), Attention Deficit Hyperactivity Disorder (ADHD), anxiety disorder and depression in sufferers thereof.

### BACKGROUND TO THE INVENTION

Neuropsychiatry is the branch of medicine dealing with mental disorders attributable to diseases of the nervous system. It preceded the current disciplines of psychiatry and neurology and today neurology and psychiatry are typically practiced separately. Nevertheless, neuropsychiatry has become a growing subspecialty of psychiatry and it is also closely related to the field of behavioral neurology, which is a subspecialty of neurology that addresses clinical problems of cognition and/or behavior caused by brain injury or brain disease. Neuropsychiatric disorders include, among many others, depression, obsessive compulsive disorder, schizophrenia, eating disorders, bipolar disorders, anxiety disorders, attention deficit disorder and attention deficit hyperactivity disorder.

Attention Deficit Disorder (ADD) and the related Attention Deficit Hyperactivity Disorder (ADHD) are the most common developmental disorders in children. It is estimated that 3 to 5% of the world's children suffer from ADHD and it persists in over 2% of adults. ADHD is a chronic disorder with 30% to 50% of children diagnosed with ADHD continuing to display symptoms in adulthood. Symptoms include inattention, easy distractibility, disorganization, impulsivity, indecision, poor time management, procrastination and forgetfulness, as well as hyperactivity.

Substantial efforts have been made to find effective treatments for ADD/ADHD. Pharmaceutical treatments, predominantly stimulant drugs, are the usual first-line form of treatment. However, the growing number of patients now being diagnosed with ADD/ADHD and the associated increasing use of stimulant drugs has generated public concern. Some studies have raised questions about the long term effectiveness and adverse side effects of medications used to treat ADD/ADHD.

Methylphenidate (ritalin) is the most commonly prescribed pharmaceutical for the treatment of ADD/ADHD. In the US, methylphenidate is classed as having a recognized medical value but with a likelihood for abuse with addictive potential. In addition, in the US. methylphenidate and other ADD/ADHD drugs including dexamphetamine and atomoxetine, carry a warning that their use can involve a risk of cardiovascular effects, growth suppression and the development of psychosis or other psychiatric conditions. Rare cases of sudden death have also been reported in children using these drugs.

Thus, there is disagreement about the appropriateness of the use of stimulant medications in the treatment of ADD/ADHD and drug-based management of ADD/ADHD is not seen as a universally positive form of treatment. A number of non-pharmaceutical treatments for ADD/ADHD have also been suggested. Biobehavioural interventions, including biofeedback and neurofeedback methods have been proposed as possible alternative ADD/ADHD management strategies.

Biofeedback is the process of becoming aware of various physiological functions using instruments that provide information on the activity of those same systems, with a goal of being able to manipulate them at will. Biofeedback methods comprise the measurement of physiological activity such as brainwaves, heart function, breathing, muscle activity, and skin temperature. The measurements are fed back to the patient in the form of a visual image, sound or other presentation. The presentation of this information is instant or near instant and permits the patient to try and modify their behaviour, thoughts or emotions in an attempt to modify the physiological activity being measured in a positive way.

For instance, heart rate can be monitored and presented to a patient suffering from stress in the form of a visual image. The image may move, change colour or size as a function of heart rate. The patient can be asked to breathe differently, try to relax, or think certain thoughts in an attempt to reduce their heart rate. The success of their efforts can be seen immediately by reference to whether or not there have been the appropriate changes in the visual image. In this way, the behaviour, thoughts or emotions which lead to a reduction in heart rate in the patient can be learnt. Over time, these changes can endure without continued use of the biofeedback instrument/device.

EP 1219233 discloses a method of treating ADHD comprising the use of a biofeedback device. The treatment method comprises having the patient view an image on screen and monitoring the fluctuation of the temperature of the skin at the fingertips of the patient. Temperature decreases in response to stress as a result of decreased blood flow to the extremities. Conversely, when the patient is relaxed, fingertip skin temperature increases. The treatment method comprises providing an obscured image on screen and asking the patient to look at it. This will result in the ADHD patient experiencing stress since a lack of visual stimulation is known to cause stress in such patients. The induced stress causes a decrease in fingertip skin temperature. The patient is encouraged to relax, and the relaxation is detected by a rise in skin fingertip temperature. The biofeedback device detects this increase and, as a result, gradually reveals the on-screen image, which results in a positive experience for the patient. In this way, by relaxing the patient, the symptoms of ADHD are said to be treated.

Anxiety disorder and depression are the most common mental illnesses in the world. The two conditions are often suffered simultaneously.

Anxiety is prevalent in the population at a level of about 15% and can have its onset in childhood, adolescence or adulthood. It is more common in females; 55 to 60% of sufferers are female. Symptoms include excessive anxiety and worry, restlessness, fatigue, difficulty concentrating, irritability, muscle tension, sleep disturbance and the feeling of being on edge.

Depression is also more common in females (2.0 to 9.3% of the population) than in males (1.8 to 3.2% of the population). Typically, onset occurs around 30 years of age, but may occur earlier or later. Symptoms include appetite loss, weight loss, change in sleep patterns such as early morning waking, insomnia and broken sleep, psychomotor activity, decreased energy, difficulty concentrating, feelings of worthlessness or guilt and suicidal thoughts.

As with other neuropsychiatric disorders, anxiety disorders and depression are commonly treated with medication, although psychotherapy and, in extreme cases of depression, electroconvulsive therapy, are also used.

Antidepressants such as selective serotonin reuptake inhibitors including Zoloft (sertraline) are primarily used to treat depression in adult since they have been shown to be more effective than current psychotherapeutic treatments in the majority of cases. Other commonly prescribed antidepressants include bupropion, Venlafaxine, fluoxetine, escitalopram, mirtazapine and Monoamine oxidase inhibitors.

The extent to which medication is prescribed is a subject of controversy (in 2007 sertraline was prescribed 29,652,000 times in the US alone) and the side effects of antidepressants are notable. Common side effects include sexual problems, drowsiness, sleep difficulties, nausea, increased risk of suicide, fatigue, weight gain, nervousness, dry mouth, and blurred vision. Antidepressants can also cause serious withdrawal symptoms if a patient stops taking them abruptly. In adults over the age of 65 further side effects include an increase risk of falls, fractures, and bone loss. Short-term withdrawal symptoms in newborns may occur if antidepressants are prescribed during pregnancy. Typical symptoms include tremor, restlessness, mild respiratory problems, and weak cry.

SSRIs are also used as first line agents to treat anxiety disorder. Other anxiety disorder medications include Serotonin-norepinephrine reuptake inhibitors (SNRIs) such as venlafaxine, Benzodiazepines, Monoamine oxidase inhibitors, the GABA analogue pregabalin (Lyr ica) and mirtazapine, TCAs such as imipramine, atypical antipsychotics such as quetiapine, and piperazines such as hydroxyzine. Many similar drugs are administered for the treatment of anxiety disorder as for depression. The drugs have similar side effects to the antidepressants discussed above.

Electroconvulsive therapy (ECT) is a procedure whereby pulses of electricity are sent through the brain via two electrodes, usually one on each temple, to induce a seizure while the patient is under a brief period of general anaesthesia. Common adverse effects from ECT include short and long-term memory loss, disorientation and headache. ECT is a particularly controversial treatment.

Methods of treatment comprising biofeedback have also been proposed for anxiety disorder and depression. For instance, U.S. Pat. No. 5,280,793 discloses a method of treating depression characterised by a particular pathological asymmetry between brain waves measured from two locations of the scalp. The method comprises the steps of attaching a first and second electrodes to different scalp locations of the patient. Brain waves of the patient are recorded from the first and second electrodes. These brain waves are used for the purpose of biofeedback. Specifically, a perceivable index of the brain wave asymmetry is presented to the patient and the patient is rewarded for changing asymmetry.

Other biofeedback methods of treating anxiety and depression in patients are known in the art. The understanding in the field is that anxiety and depression may be treated by inducing a relaxed state in the patient, i.e. by increasing parasympathetic activity in the patient. However, there remains a need for further effective methods of treating neuropsychiatric disorders which do not comprise medication, at least as the sole form of treatment.

### BRIEF DESCRIPTION OF THE DRAWINGS

FIG. 1 graphically illustrates the results of a preliminary study utilizing the invention. Changes in Digit Span score in non-ADHD subjects before and after biofeedback treatment are shown. The participants were trained using a GSR Biofeedback method to increase sympathetic activity.

FIG. 2 graphically illustrates the results of a further preliminary study utilizing the invention. Changes Anxiety and Depression levels in non-Anxiety/Depression subjects are shown. The participants were trained using a GSR Biofeedback method to increase sympathetic activity.

### GENERAL DESCRIPTION OF THE INVENTION

The present inventor has, for the first time, identified that neuropsychiatric disorders can be treated using a biofeedback method in which sympathetic activity in the patient is enhanced. This surprising finding is counterintuitive and is a substantial deviation from the biofeedback treatments known in the art, which increase the level of relaxation in a subject. The methods of the present invention involve the induction of sympathetic activity in the patient and, surprisingly, it has been demonstrated that such methods are effective in the treatment of neuropsychiatric disorders.

In a first aspect, the present invention provides a method of treating a sufferer of a neuropsychiatric disorder by way of biofeedback training, said training comprising a series of training sessions, in each of which the sympathetic nervous activity of the sufferer is monitored, the sufferer is requested to and/or does observe a presentation which is a function of their sympathetic nervous activity and the sufferer is requested to and/or does influence the presentation in a way which corresponds to an increase in sympathetic nervous activity. In embodiments of the invention, the method comprises monitoring the sympathetic nervous activity of the sufferer using an apparatus or device configured for monitoring the sympathetic nervous activity of the suffer. The apparatus may be any suitable apparatus, and may be configured to carry out a method of monitoring the sympathetic nervous activity of the sufferer in any of the manners described herein. Preferably the apparatus is a biofeedback apparatus as discussed below. The apparatus preferably forms part of a biofeedback training apparatus as described below.

Techniques for monitoring the sympathetic nervous activity of a subject are well-known in the field and any such technique can be used in the methods of the present invention. The techniques involve monitoring a physiological parameter of the subject which is associated with sympathetic nervous activity, and may be implemented using a device or apparatus configured to monitor such a parameter of the subject. For instance, the heart rate of the sufferer can be monitored; an increase in heart rate indicates an increase in sympathetic nervous activity. Alternatively, the blood pressure of the sufferer can be monitored; an increase in blood pressure indicates an increase in sympathetic nervous activity. Alternatively, the pupil dilation of the sufferer can be monitored; a decrease in pupil size indicates an increase in sympathetic nervous activity. Alternatively, heart rate variability of the sufferer can be monitored; a decrease in heart rate variability indicates an increase in sympathetic nervous activity. Preferably however, the galvanic skin response of the sufferer is monitored; a decrease in skin resistance indicates an increase in sympathetic nervous activity. Accordingly, an apparatus used for monitoring the sympathetic nervous activity of the sufferer may comprise an arrangement for monitoring a heart rate of the sufferer, the blood pressure of the sufferer, the pupil dilation of the sufferer, or preferably the galvanic skin response of the sufferer. The arrangement is at least able to measure the given parameter, directly or indirectly. The apparatus may be arranged to monitor the activity automatically or in response to intervention by a conductor of the treatment method (trainer).

In embodiments an apparatus for monitoring the sympathetic nervous activity of a sufferer, e.g. for monitoring a physiological parameter associated with sympathetic nervous activity, comprises at least an arrangement for measuring e.g. sensing the physiological parameter, and may comprise a set of one or more processors (or a controller) for controlling operation of the measurement arrangement so as to monitor the parameter e.g. in a desired manner. The arrangement for measuring the parameter may comprise any suitable instrument(s). The set of one or more processors are arranged e.g. programmed to cause the measuring arrangement to carry out the desired monitoring i.e. to take measurements according to a monitoring regime. This may enable monitoring to be carried out automatically, and potentially remotely, rather than under the supervision of a human test conductor. The apparatus may be arranged such that the set of one or more processors is programmable to allow a desired monitoring regime to be input e.g. by a person conducting the treatment method. In some embodiments the set of one or more processors is provided by a computer apparatus e.g. PC. Thus the monitoring may be carried out using a suitable measuring apparatus in communication with a computer e.g. PC.

It has long been known that the galvanic skin response (GSR), conventionally measured by the resistance between two electrodes applied spaced apart to the skin, varies with the degree of alertness or relaxation of the subject. A decrease in skin resistance, i.e. an increase in skin conductivity is associated with an increase in sympathetic nervous activity. In contrast, an increase in skin resistance, i.e. a decrease in skin conductivity is associated with a decrease in sympathetic nervous activity and an associated increase in relaxation. In embodiments, the present invention comprises using an apparatus for monitoring the galvanic skin response of the sufferer comprising a pair of electrodes which may be applied spaced apart to the skin, and an arrangement for measuring the resistance between the two electrodes.

The GSR phenomenon has been used in the past to assist in training people to relax, For instance, WO 93/02622 describes apparatus for assisting relaxation in which a screen display showing a computer-generated animation is viewed by a user whose galvanic skin response is continuously monitored. As the resistance between the electrodes changes, so the animation may be controlled by a suitable programme to give the user a directly perceptible indication of whether they are becoming more relaxed or more tense, for example by seeing whether an animated fish seen against an underwater landscape is swimming to the left or to the right. After some practice, users learn to be able to influence the movement seen on screen to be predominantly in the desired direction corresponding to greater relaxation, i.e. they learn to relax.

However, in the methods of the present invention, the sufferer undergoing treatment is encouraged to influence the presentation in a way which corresponds to an increase in sympathetic activity. The term “sympathetic activity” is well known in the field as meaning the activity of the sympathetic nervous system, rather than the parasympathetic nervous system.

In the preferred methods of the present invention, in which the GSR of the sufferer is monitored, the sufferer undergoing treatment is encouraged to influence the presentation in a way which corresponds to a decrease in skin resistance, i.e. an increase in skin conductivity, which is indicative of an increase in sympathetic activity.

The terms “biofeedback”, “biofeedback training” and “biofeedback device” are well-known by those of ordinary skill in the art. Biofeedback is the process of becoming aware of various physiological functions using instruments that provide information on the activity of those same systems, with a goal of being able to manipulate them at will. The biofeedback training of the present invention may be implemented using any suitable biofeedback training apparatus comprising a biofeedback apparatus as discussed herein.

The present invention utilises the known link between any one of a number of physiological parameters and the sympathetic activity of the user.

In the preferred methods of the present invention, biofeedback training is the process of making the sufferer of the neuropsychiatric disorder become aware of the degree of their sympathetic nervous activity using a device that monitors the GSR of the sufferer and converts the GSR measurements taken into a presentation which can be observed by the sufferer. Thus, in the preferred present methods, the GSR of the patient is monitored and the GSR measurements are converted by a biofeedback device into a presentation for the sufferer. In this way, the sufferer is requested to observe a presentation which is a function of their galvanic skin response.

In the methods of the present invention, a physiological parameter of the patient which is associated with sympathetic nervous activity is monitored. Preferably this parameter is the galvanic skin response. The term “monitored” means that GSR or other measurements are taken at a frequency and over a timeframe determined by the person conducting the treatment method. The appropriate frequency and timeframe of the measurements will be readily determinable by the skilled man. The monitoring may be carried out by programming an apparatus for monitoring the nervous activity or physiological parameter appropriately, or may be carried out upon intervention by the person conducting the method. A conductor may set up an appropriate program which will result in desired monitoring being carried out automatically. For example, this may enable training to be carried out at a remote location e.g. at a user's home, via a PC, without the trainer needing to be present. Preferably the GSR or other parameter of the sufferer is measured continually during the training session.

Methods of monitoring physiological parameters associated with sympathetic nervous activity are well-known to those of ordinary skill in the art and any such method may be used. Preferably, GSR is measured by the resistance between two electrodes applied spaced apart to the skin. The GSR measurement varies with the degree of alertness or relaxation of the subject. A decrease in skin resistance, i.e. an increase in skin conductivity is associated with an increase in sympathetic nervous activity. In contrast, an increase in skin resistance, i.e. a decrease in skin conductivity is associated with a decrease in sympathetic nervous activity and an associated increase in relaxation.

Biofeedback devices or apparatus which can utilise GSR or other measurements are widely available and any such device may be used in the methods of the present invention. Typically the devices comprise a program which converts the GSR or other measurements into a presentation for the sufferer to observe. Examples of such suitable devices are disclosed in WO 93/002622, GB 2,409,278, GB 2,2378762 and WO 1999/041654. U.S. Pat. No. 7,734,338 discloses that the GSR biofeedback method of the present invention substantially improves the condition of sufferers of epilepsy. Epilepsy is a neurological disease, not a neuropsychiatric disorder.

In preferred embodiments the apparatus for monitoring the sympathetic nervous activity of the sufferer is a biofeedback apparatus. Preferably the biofeedback apparatus or device is arranged to use e.g. convert the results of the monitoring e.g. measurements of the physiological parameter e.g. GSR associated with sympathetic nervous activity to provide the presentation which the sufferer is requested to observe. In embodiments the sympathetic nervous activity of the sufferer is monitored using a biofeedback apparatus, the biofeedback apparatus being arranged to use the results of the monitoring to provide the presentation which is a function of the sympathetic nervous activity of the sufferer. The apparatus may comprise a set of one or more processors suitably programmed to use the results of the monitoring to provide the presentation. In some embodiments the apparatus comprises a computer apparatus e.g. PC which uses the results of the monitoring to provide the presentation.

In embodiments the apparatus is arranged to store the results of the monitoring. This may enable a trainer to subsequently review the performance of the sufferer and tailor future training sessions appropriately.

In embodiments the method comprises using a biofeedback apparatus comprising an arrangement for measuring a physiological parameter e.g. GSR associated with sympathetic nervous activity, the arrangement being in communication with a set of one or more processors arranged to control the operation of the measuring arrangement and to use the results of the measuring to provide the presentation in accordance with the methods described herein. The set of one or more processors may be provided by a computer apparatus e.g. PC.

In embodiments, regardless of whether it is provided by a biofeedback apparatus, the presentation e.g. animation is computer generated.

Preferably the presentation is in the form of a visual image, preferably an animation. The presentation may alternatively or additionally comprise an auditory presentation.

Preferably the method comprises using an apparatus e.g. the biofeedback apparatus that provides or outputs the results of the GSR monitoring (or the monitoring of other parameters) to the sufferer in the form of a visual image, more preferably an animation. However, auditory, physical and olfactory presentations and combinations of any of these presentations are also included within the scope of the present invention. In embodiments the method comprises providing a presentation in the form of a visual image to the sufferer on a display e.g. display screen. In embodiments using other types of presentation, the apparatus may alternatively or additionally comprise a suitable auditory or other presentation device for providing or outputting the relevant type of presentation. In embodiments using a biofeedback apparatus, the apparatus may comprise a suitable visual display. In embodiments a set of one or more processors is arranged to use the results of the monitoring to determine a presentation, and to cause the presentation to be output e.g. displayed to a sufferer. presentation is a function of the sufferer's galvanic skin response or other parameter associated with sympathetic nervous activity. Thus, in the preferred methods of the present invention, the GSR of the patient is monitored and the patient is presented with a visual image which is representative of the GSR measurement. The changes in the visual image over time indicate to the sufferer whether the GSR measurements are increasingly positive or negative, i.e. whether skin resistance is decreasing (associated with increasing sympathetic activity) or increasing (associated with decreasing sympathetic activity).

The sufferer is requested to attempt to influence the presentation by controlling the monitored physiological parameter, preferably their GSR, in such a way as to increase their sympathetic activity. In the preferred GSR techniques of the present invention, the sufferer is requested to influence the presentation by controlling their GSR in such a way as to decrease their skin resistance.

The concept of consciously controlling one's own skin resistance, or many other physiological parameters, is most likely alien to the sufferer. However, the use of the biofeedback device or apparatus permits the sufferer to asses the extent to which their attempts have been successful or unsuccessful by reference to the presentation, which will change as a function of the GSR or other measurement. In other words, the sufferer is presented with a directly perceptible indication of whether they are becoming more or less sympathetically active, i.e. in the preferred methods, whether their skin resistance is decreasing or increasing. By way of example only, the presentation may comprise an animated fish seen against an underwater landscape, said fish swimming to the right if skin resistance is decreasing and to the left if skin resistance is increasing. After some practice, sufferers learn to be able to control the movement seen on screen to be predominantly in the desired direction (right in this case).

By repetition and practice, over a number of training sessions, the sufferer can be taught the skill of influencing their skin resistance or other parameter associated with their sympathetic nervous activity. This teaching may carried out using a suitable computer implemented training system. In embodiments the biofeedback training method is a computer implemented method. The method may be wholly or partially computer implemented. In embodiments the method of the invention is implemented using a biofeedback training apparatus comprising a biofeedback apparatus for monitoring the sympathetic nervous activity of the sufferer and using the results of the monitoring to provide the presentation.

The training apparatus may further be arranged to provide instructions to or request that the sufferer observe the presentation and try to influence the presentation in a way which corresponds to an increase in sympathetic nervous activity. In other words, the apparatus may be arranged to deliver a training session or sessions. This may be carried out under the control of a set of one or more processors. The instructions may be provided via a suitable output or outputs, e.g. via a display screen and/or auditory output. In embodiments the training apparatus is implemented using a computer apparatus e.g. PC suitably programmed and in communication with a biofeedback apparatus and the instructions may be provided to the sufferer via the computer apparatus. Of course, in other arrangements, the training may be carried out under the supervision of a trainer, who would provide the necessary instructions to the user. Thus the biofeedback training apparatus may simply comprise the biofeedback apparatus as described above, or may additionally comprise a set of one or more processors suitably programmed to provide instructions to a sufferer to implement a training session. Training may then be delivered automatically or remotely.

Preferably, the neuropsychiatric disorder is selected from the group consisting of attention deficit disorder, attention deficit hyperactivity disorder, mood disorders and anxiety disorders. Preferably the mood disorder is depression, more preferably major depressive disorder. Preferably the anxiety disorder is selected from the group consisting of generalized anxiety disorder (GAD), panic disorder, phobias, social anxiety disorder, obsessive-compulsive disorder (OCD), post-traumatic stress disorder (PTSD) and separation anxiety.

“Treatment” or “treating” as used herein includes, but is not limited to stabilisation e.g. treatment of a condition or disorder which would worsen if left untreated but which does not result in cure of the disease. “Treatment” or “treating” includes a measurable and beneficial improvement in one or more, preferably more than one symptom of a condition or disorder. Preferably the term “treatment” or “treating” includes a conclusion by the treating physician that the condition or disorder is improved in terms of the historical presentation of the condition or disorder. The symptoms of neuropsychiatric disorders are well-characterised.

If the disorder is ADD or ADHD then preferably the methods of the present invention treat the symptom of inattention, preferably measured by Digit Span score. If the disorder is depression or an anxiety disorder then preferably the methods of the present invention treat the symptom of depression level and anxiety level, preferably measured by Hospital Anxiety and Depression Scale score.

The number, frequency and duration of each training session will be readily determinable by the conductor of the treatment method. The treatment is preferably carried out as a series of 10 to 20 regular training sessions spaced over a period of 10 to 60 days, each session lasting at least 10 minutes, but usually no longer than 40 minutes. During each session the subject tries to follow the instruction to make the presentation reflect a decrease in skin resistance, but preferably without recourse to physical activity, merely by mental activity. More preferably, treatment comprises between 10 to 15 training sessions, spaced over a period of 30 days and each session lasting between 10 and 40 minutes.

The effects of such training do not fade rapidly. In some cases there can be effective permanent improvement, while in others it may be desirable to repeat a training procedure, but the intervals appropriate for such repetition may vary widely from one patient to another.

Without wishing to be bound by theory, the reduction in symptoms is thought to stem, in part, from measurable changes in the brain which are not consciously perceptible by the sufferer. In addition, however, the severity of symptoms is thought to be decreased at least in part voluntarily by conscious effort on the part of the sufferer who, when they experience symptoms, can call back to mind the memory of the training sessions, which seems to decrease the severity of the symptoms. Alternatively, a sufferer not experiencing symptoms at a particular time may call back to mind the memory of the training sessions in order to prevent the occurrence of symptoms.

The simple biofeedback technique used involves the use of suitable biofeedback apparatus, preferably incorporating low power consumption compact visual display and/or auditory devices. This enables sufferers of neuropsychiatric disorders to be provided with apparatus for use in carrying out the method of the invention which can be used at home and thus easily and quickly deployed when desired by the sufferer with a view to improving their disorder. In embodiments the method of the present invention is implemented via a web based user interface.

As can be easily appreciated, such apparatus may be analogous to the apparatus used in a clinical setting, e.g. in an outpatient department, to provide the sufferer with the initial training in management of their disorder according to the invention. In the case of apparatus for use in a clinical setting, however, the apparatus may be designed to record other patient data during training sessions with a view to improved monitoring and diagnosis.

Indeed, in a clinical setting, the therapist may be able to assess the susceptibility of any particular sufferer to changes in their physiological, psychological or emotional state, and tailor both biofeedback training sessions and downstream online monitoring using communications technology, to match the needs of the sufferer in question. Preferably, patients have access to an online platform by password and username and the training sessions may be monitored by the therapist to prevent inappropriate use.

The present invention extends to a computer program comprising computer readable instructions executable to perform a method in accordance with the invention in any of its aspects or embodiments.

The present invention further extends to a computer readable medium comprising software which, when run on a set of one or more processors, implements the method of any of the embodiments of the invention.

Various documents including, for example, publications and patents, are recited throughout this disclosure. All such documents are, in relevant part, hereby incorporated by reference. The citation of any given document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The methods described herein may comprise, consist essentially of, or consist of any of the method steps as described herein.

For the purpose of this specification it will be clearly understood that the word “comprising” means “including but not limited to”, and that the word “comprises” have a corresponding meaning. Therefore the words “comprise”, “comprises”, and “comprising” are to be interpreted inclusively rather than exclusively.

As used herein and in the appended claims, the singular forms “a,” “an,” and “the” include plural reference unless the context clearly dictates otherwise.

Unless defined otherwise, all technical and scientific terms and any acronyms used herein have the same meanings as commonly understood by one of ordinary skill in the art in the field of the invention.

The following Examples are intended to be illustrative of the present invention and to teach one of ordinary skill in the art to make and use the invention. These Examples are not intended to limit the invention in any way.

### Example 1

### Preliminary Results for ADHD

Ten subjects not suffering from ADHD were available. Subjects underwent biofeedback training sessions three times a week for four weeks. In each training session subjects were encouraged to attempt to increase their sympathetic activity, i.e. to decrease their skin resistance. A GSR biofeedback device (as described in WO 93/02622, which was modified for scientific purposes) was used by the subjects during each training session An animation sequence programmed into a PC showed a fish swimming to left or right against a background scene. All subjects were asked to attempt to make the fish swim to the right by increasing their sympathetic activity (mental alertness), preferably without making physical movements, and without closing their eyes.

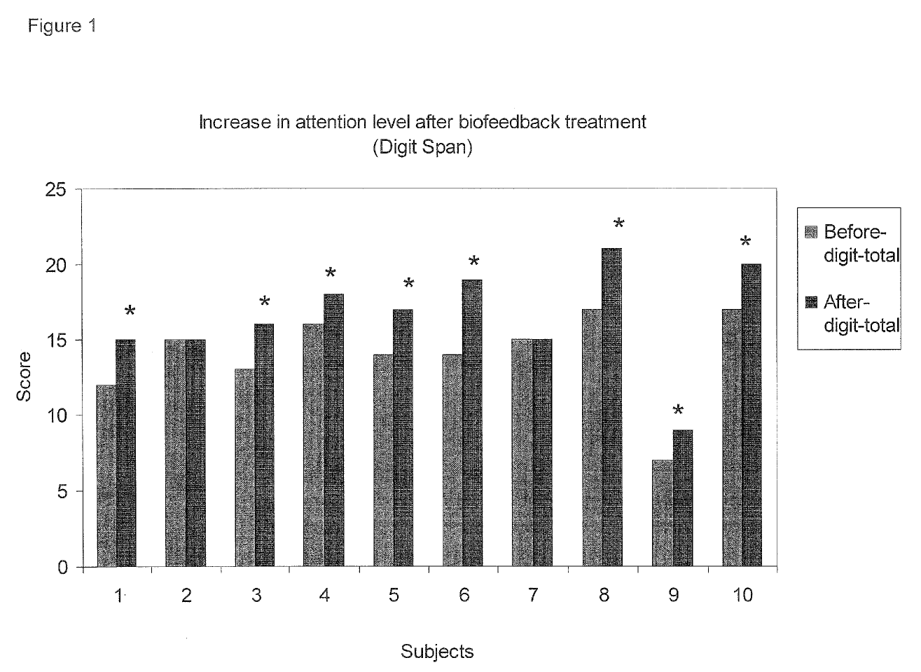

Digit Span is a standard measure of attention level. Digit Span scores were taken before and at the end of the four week period treatment period. The results are shown in FIG. 1, which demonstrates that the GSR biofeedback training significantly enhanced the subjects' attention (t=−5.00, df=9, p<0.001). Mean score of attentional measurement before treatment was 14.0±2.94 and after treatment 16.50±3.41.

### Example 2

### Preliminary Results for Depression/Anxiety Disorder

Nine subjects not suffering from anxiety or depression were available. Subjects underwent biofeedback training sessions three times a week for four weeks. In each training session subjects were encouraged to attempt to increase their sympathetic activity, i.e. to decrease their skin resistance. A GSR biofeedback device (as described in WO 93/02622, which was modified for scientific purposes) was used by the subjects during each training session An animation sequence programmed into a PC showed a fish swimming to left or right against a background scene. All subjects were asked to attempt to make the fish swim to the right by increasing their sympathetic activity (mental alertness), preferably without making physical movements, and without closing their eyes.

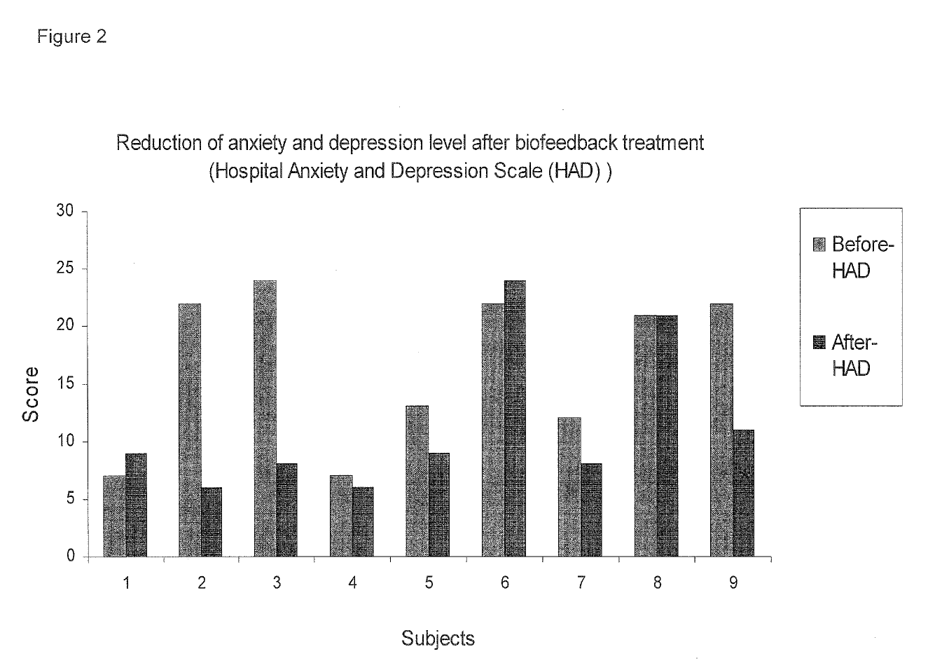

The Hospital Anxiety and Depression Scale (HAD) is a standard measure of anxiety and depression levels. HAD scores were taken before and at the end of the four week period treatment period. The results are shown in FIG. 2, which demonstrates that the GSR biofeedback training had tendency to reduce the subjects' HAD scores (t=2.02, p=0.07). Mean score of anxiety and depression scale before treatment was 15.6±7.32 and after treatment 11.00±6.27.

1. A method of treating a sufferer of a neuropsychiatric disorder by way of biofeedback training, said training comprising a series of training sessions, in each of which the sympathetic nervous activity of the sufferer is monitored, the sufferer observes a presentation which is a function of their sympathetic nervous activity and the sufferer influences the presentation in a way which corresponds to an increase in sympathetic nervous activity.

2. The method of claim 1, wherein the sympathetic activity of the sufferer is monitored by monitoring their galvanic skin response, wherein the sufferer observes a presentation which is a function of their galvanic skin response and wherein the sufferer influences the presentation in a way which corresponds to a decrease in skin resistance.

3. The method of claim 1, wherein the neuropsychiatric disorder is selected from the group consisting of attention deficit disorder (ADD), attention deficit hyperactivity disorder (ADHD), mood disorders and an anxiety disorders.

4. The method of claim 3, wherein the neuropsychiatric disorder is ADHD.

5. The method of claim 3, wherein the mood disorder is depression.

6. The method of claim 5, wherein the depression is major depressive disorder.

7. The method of claim 3, wherein the anxiety disorder is selected from the group consisting of generalized anxiety disorder (GAD), panic disorder, phobias, social anxiety disorder, obsessive-compulsive disorder (OCD), post-traumatic stress disorder (PTSD) and separation anxiety.

8. The method of claim 7, wherein the anxiety disorder is generalized anxiety disorder.

9. The method of claim 1, wherein the sufferer suffers from both depression and an anxiety disorder and wherein said method treats both disorders.

10. The method of claim 1, wherein the presentation is in the form of a visual image provided on a display screen.

11. The method of claim 1, wherein the presentation is a computer generated presentation.

12. The method of any of claim 1, wherein the presentation is an auditory presentation.

13. The method of claim 1 wherein the presentation is an animation provided on a display screen.

14. The method of claim 1, wherein the attention level of the sufferer is increased.

15. The method of claim 14, wherein attention level is measured by Digit Span score.

16. The method of claim 1, wherein the training sessions are between 10 and 20 in number, spaced over a period of 10 to 60 days and each session lasting between 10 and 40 minutes.

17. The method of claim 16, wherein the training sessions are 10 to 15 in number, spaced over a period of 30 days and each session lasting between 10 and 40 minutes.

18. The method of claim 1 wherein the sympathetic nervous activity is monitored using a biofeedback apparatus comprising an arrangement for monitoring a physiological parameter of the sufferer, the parameter being a heart rate of the sufferer, the blood pressure of the sufferer, the pupil dilation of the suffer, or the galvanic skin response of the sufferer.

19. The method of claim 2 wherein the galvanic skin response is monitored using an apparatus comprising a pair of electrodes which may be applied spaced apart to the skin, and an arrangement for measuring the resistance between the two electrodes.

20. The method of claim 1 wherein the sympathetic nervous activity of the sufferer is monitored using a biofeedback apparatus, the apparatus being arranged to use the results of the monitoring to provide the presentation.
